(19) United States
(12) Patent Application Publication
(10) Pub. No.: US 2006/0037156 A1
(43) Pub. Date: Feb. 23, 2006

(54) Magnetic cleaning apparatus and method

(76) Inventor: Chad VanHulzen, Palatine, IL (US)

Correspondence Address: Allison Dudley, 1712 W. North Ave., #2, Chicago, IL, 60622, US

(21) Appl. No.: 11/135,207

(22) Filed: May 23, 2005

Related U.S. Application Data
(63) Continuation-in-part of application No. 10/921,652, filed on Aug. 19, 2004.

(51) Int. Cl. A47L 15/00; B44D 3/00

(52) U.S. Cl. 15/1; 15/59

(57) ABSTRACT

The present invention is a method and apparatus for cleaning the surfaces of a container with an interior portion, for example a vase or bottle. The present invention is a magnetic apparatus and method that includes a major unit and a minor unit that are magnetically coupled. The magnetic cleaning apparatus cleans the surfaces of a container as it is moved in conjunction (maintaining a magnetic connection) along the inside and outside surfaces of the container. The cleaning apparatus efficiently and effectively cleans the residue that builds up on the surfaces of a container, but also provides entertainment.

This application is a continuation-in-part of U.S. patent Ser. No. 10/921,652 filed Aug. 19, 2004.

### FIELD OF THE INVENTION

The present invention relates generally to a cleaning apparatus and method. Most particularly, the invention relates to a magnetic apparatus and method for cleaning containers with an interior portion, for example vases or bottles.

### BACKGROUND OF THE INVENTION

Containers, such as vases or other devices, for example bottles, have sufficient open areas that allow the interior portion to be cleaned by hand. However, with containers having a narrow dimension opening to the interior portion does not allow easy access to the interior portion for cleaning.

Residue may build up within a container. For example, residue typically builds up within a vase holding flowers. A scrupulously clean vase keeps flowers fresh longer. A dirty vase leads to dirty water where bacteria can shorten the vase life of flowers.

Cleaning solutions can be used to access to the interior portion for cleaning, but are often insufficient and may be hazardous. Thus, there is a need for a cleaning apparatus and method that efficiently and effectively cleans the residue that may build up on the inside surfaces of a container, but that can also provide entertainment.

### SUMMARY OF THE INVENTION

The present invention is a two piece magnetically coupled apparatus that efficiently and effectively cleans surfaces, for example an interior portion of a container. The present invention removes residue from containers constructed of any composition, for example glass, Plexiglas, ceramic, clay, porcelain and plastic. Container, vase and bottle are used interchangeably herein.

The present invention includes a major unit and a minor unit that are magnetically coupled. An aspect of the present invention is to clean the surfaces of a container as the major unit and minor unit are moved along the surfaces of the container maintaining the magnetic connection. The major unit is positioned on the outside surface of a container while the minor unit is positioned on the inside surface of the container.

An object of the present invention is to provide a textured element on the minor unit for cleaning the inside surfaces, or interior portion, of a container. It is contemplated that the textured element may be on the major unit for cleaning outside surfaces of a container. The textured element can be a material that scrapes or scrubs the residue off or away from the surfaces of the container. The textured element can be a separate element that is attached to a surface of the minor unit (positioned on the interior portion, or inside surface, of the container), for example, Velcro, felt or rough fibers. The textured element may also be integrated with the minor unit, for example, a beveled surface, raised channels or continuous peaks and valleys.

It is further contemplated the end of the minor unit positioned on the inside surface of the container may be rounded or convex to effectively clean residue of contoured features of the container, for example a vase with corners, arched or curved surfaces.

A further object of the present invention is to provide an ergonomically designed cleaning apparatus for easy manipulation. The major unit acts as a handle. It has circular cross section that is tapered from a first end to a second end, although any shaped cross section is contemplated. Further, the first end of the major unit could extend to the second end. Taper is to become gradually narrower or thinner and extend is to elongate or lengthen in a straight fashion.

Yet another object of the present invention is to provide a receptacle or compartment positioned within the major unit for placing and storing items, for example flower food.

The present invention will be further appreciated, and its attributes and advantages further understood, with reference to the detailed description below of some presently contemplated embodiments, taken in conjunction with the accompanying drawings, in which:

### BRIEF DESCRIPTION OF THE DRAWINGS

FIG. 1 is a perspective view of an assembled magnetic cleaning apparatus made in accordance with certain aspects of the invention;

FIG. 2 is a cross sectional view of a magnetic cleaning apparatus made in accordance with this invention;

FIG. 3 is an exploded view of a magnetic cleaning apparatus made in accordance with this invention; and

FIG. 4 is a perspective view of a magnetic cleaning apparatus and a container, more specifically a vase.

### DETAILED DESCRIPTION OF EMBODIMENTS OF THE INVENTION

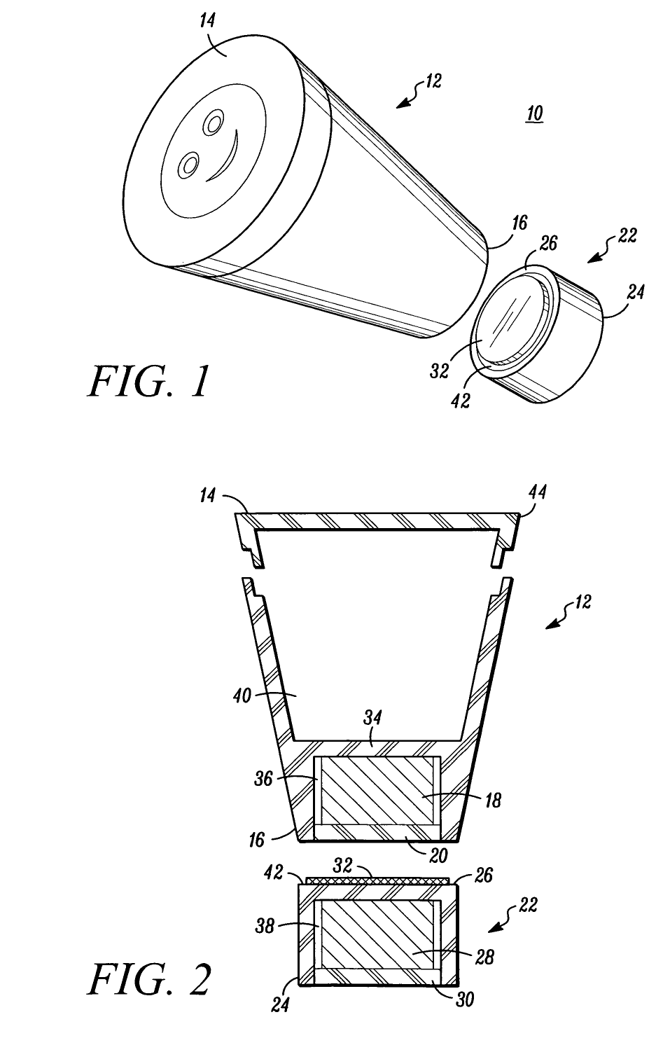

The present invention is a cleaning apparatus and method that efficiently and effectively cleans the residue that may build up on the surface of a container. A major unit 12 and a minor unit 22 (FIG. 1) are magnetically coupled such that the surfaces of a container are cleaned when the major unit 12 and minor unit 22 are moved along the surfaces of a container.

As shown in FIG. 1, the cleaning apparatus 10 includes a major unit 12 and a minor unit 22. The major unit 12 and minor unit 22 are composed of plastic, but any material is contemplated, for example, metal. The major unit longitudinally extends from a first end 14 to a second end 16 creating a substantially cylindrical shape. The first end 14 may be tapered to the second end 16 providing for a wide cross section at the first end 14 narrowing to a smaller cross section at the second end 16 (FIG. 1).

The minor unit 22 longitudinally extends from a first end 24 to a second end 26 creating a cylindrical shape. The second end 26 may be slightly bowed or convex to effectively clean residue of contoured features of a container, for example corners, arched or curved surfaces. Further, a textured element 32 is disposed on the second end 26. The textured element 32 can be a separate element, such as Velcro, felt or rough fibers, disposed on the surface of the second end 26. The textured element 32 has adhesive 42 on the opposite side thereof that mounts to the second end 26. Further, the textured element 32 can be integrated with the minor unit, for example, a beveled surface, raised channels or continuous peaks and valleys.

In reference to FIG. 2, the major unit 12 includes a top cap 44 at the first end 14. The top cap 44 is removeably connected to the major unit 12. The removable connection can, for example, be a snap fit, interference fit or a threaded arrangement for easy assembly and disassembly.

The top cap 44 creates a receptacle 40 when assembled. The receptacle 40 is formed by the top cap 44 opposing a separator 34 and the longitudinally extending walls of the major unit 12. The separator extends longitudinally across the cross section of the major unit 12. The separator 34 is integrated with the major unit 12 and is composed of the same material. The receptacle 40 can be used to for placing and storing items such as flower food. The receptacle 40 can be of any size or shape.

The separator 34 not only forms an aspect of the receptacle 40, but also forms an aspect of a cavity 36 for receiving a master magnet 18. A master magnet 18 is positioned in a first cavity 36 at the second end 16 to rest substantially near the separator 34. A first end cap 20 secures the master magnet 18 in the first cavity 36.

The minor unit 22 includes a second cavity 38. A slave magnet 28 is positioned in the second cavity 38 and secured by a second end cap 30. A textured element 32 covers the second end 26 of the minor unit 22. The textured element 32 can be any material or arrangement such that is removes residue from a container. In the preferred embodiment, the textured element 32 is a Velcro pad of the size and shape to cover the second end 26. The Velcro pad includes an adhesive 42 that bonds the pad to the second end 26 of the minor unit 22.

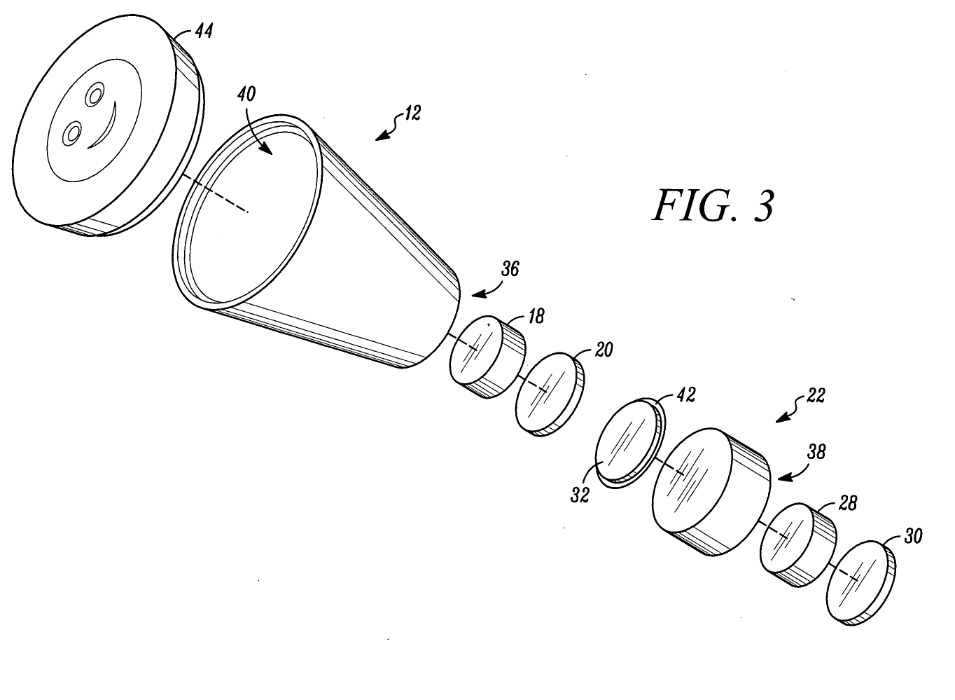

Referring to FIG. 3, the first cavity 36 receives a master magnet 18. The master magnet 18 is positioned such that it is substantially near the separator 34. A first end cap 20 is positioned at the second end 16 to secure the master magnet 18 in the first cavity 36. The second end cap 20 can be a snap fit to the second end 16 or secured by glue. The top cap 44 is assembled at the first end 14 to complete receptacle 40.

The second cavity 38 receives a slave magnet 28. A second end cap 30 is positioned at the first end 24 to secure the slave magnet 28 in the second cavity 38. The second end cap 30 can be a snap fit to the first end 24 or glued to secure the slave magnet 28 in the cavity 38. Adhesive 42 attaches the textured element 32 to the minor unit 22, although any attachment means is contemplated.

Master magnet 18 and slave magnet 28 are fields with the property, either natural or induced, of attraction. The master magnet 18 and slave magnet 28 are coupled when the fields are attracted.

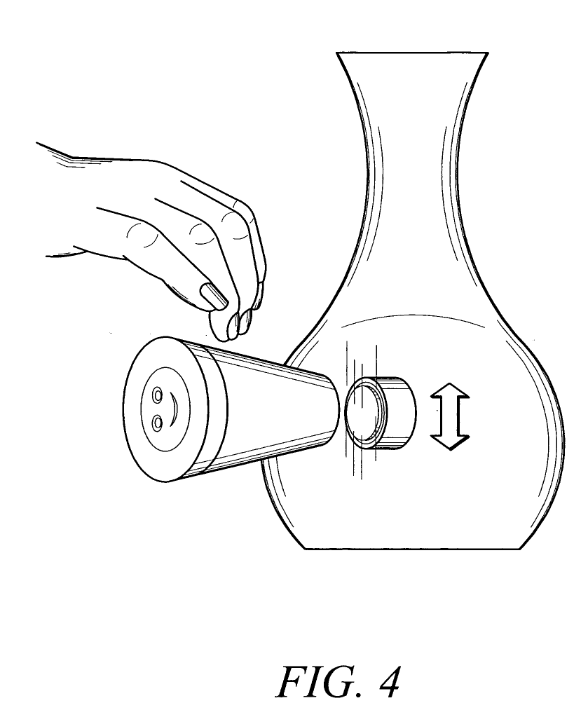

The present invention cleans the inside surface of a vase (FIG. 4). The second end 16 with first end cap 20 of the major unit 12 is positioned on the outside surface of a vase and the textured element 32 of the second end 26 of the minor unit 22 is positioned on the inside surface of the vase. The cylindrical shape of the major unit 14 provides a lever for a user to grasp onto and move the major unit 14.

The textured element 32 on the second end 26 of the minor unit 22 cleans the inside surface of a vase as the major unit 12 is moved along the outside surface of the vase. As the major unit 12 is moved along the outside surface of the vase, the magnetic connection between the major unit 12 and minor unit 22 causes the minor unit 22 to move along the inside surface of the vase in conjunction with the major unit 12. The textured element 32 scrapes or scrubs the residue off or away from the inside surface of the vase. Further, the textured element 32 may be disposed on a bowed or convex second end 26. The convex shape of the second end 26 effectively cleans residue of contoured features of the vase, for example corners, arched or curved surfaces.

Thus, while a multitude of embodiments have been variously described herein, those of skill in this art will recognize that different embodiments show different potential features/designs which can be used in the other embodiments. Even more variations, applications and modifications will still fall within the spirit and scope of the invention, all as intended to come within the ambit and reach of the following claims.

What is claimed is:

1. A magnetic cleaning apparatus, comprising:
a container having an outside surface and an inside surface;
a major unit including a first end extending to a second end, wherein a master magnet is positioned within said second end of said major unit;
said second end of said major unit placed on said outside surface of said container;
a minor unit including a first end extending to a second end, wherein a slave magnet is positioned within said first end of said minor unit; and
said second end of said minor unit placed on said inside surface of said container, wherein said minor unit and said major unit adapted to maintain a magnetically coupled relationship when said major unit is moved along said outside surface of said container.

2. The magnetic cleaning apparatus of claim 1 further comprising a top cap removeably connected to said first end of said major unit.

3. The magnetic cleaning apparatus of claim 2 wherein said top cap assembles to complete a receptacle within said major unit.

4. The magnetic cleaning apparatus of claim 1 further comprising a textured element disposed on said second end of said minor unit.

5. The magnetic cleaning apparatus of claim 4 wherein the textured element is nylon.

6. The magnetic cleaning apparatus of claim 1 wherein said first end of said major unit tapers to said second end of major unit.

7. The magnetic cleaning apparatus of claim 1 wherein said container is a vase.

8. The magnetic cleaning apparatus of claim 1 wherein said container is a bottle.

9. A magnetic cleaning apparatus for a vase, comprising:
said vase having an outside surface and an inside surface;
a major unit including a first end extending to a second end, wherein a master magnet is positioned within said second end of said major unit, a first end cap positioned over said second end concealing said master magnet;
a receptacle within said first end of said major unit;
a top cap removeably connected to said first end;
said second end of said major unit placed on said outside surface of a vase;
a minor unit including a first end extending to a second end, wherein a slave magnet is positioned within said first end of said minor unit, a second end cap positioned over said first end concealing said slave magnet, said minor unit further comprising an textured element disposed on said second end;
said second end of said minor unit placed on said inside surface of said vase, wherein said minor unit and said major unit adapted to maintain a magnetically coupled relationship when said major unit is moved along said outside surface of said vase.
